(19) United States
(12) Patent Application Publication
(10) Pub. No.: US 2003/0073002 A1
(43) Pub. Date: Apr. 17, 2003

(54) Non-aqueous electrolyte secondary battery

(76) Inventors: Naoki Imachi, Sumoto-shi (JP); Ikuro Nakane, Sumoto-shi (JP); Satoshi Narukawa, Sumoto-shi (JP)

Correspondence Address: NIXON & VANDERHYE P.C., 1100 North Glebe Road, 8th Floor, Arlington, VA, 22201-4714, US

(21) Appl. No.: 10/158,106

(22) Filed: May 31, 2002

(30) Foreign Application Priority Data
May 31, 2001 (JP) P.2001-164729

(51) Int. Cl. H01M 4/50; H01M 4/52

(52) U.S. Cl. 429/231.3; 429/224; 429/231.5; 429/231.6

(57) ABSTRACT

An object of the invention is to provide a non-aqueous electrolyte secondary battery having a plateau in voltage in the 4-V region well comparable to that of lithium cobalt oxide, a high energy density, and cell characteristics such as safety, cycle properties, and high temperature storage properties.

[Means for Resolution] A non-aqueous electrolyte secondary battery according to the present invention comprises a positive electrode containing a positive electrode active material admixed therein a lithium-containing complex oxide having a layered crystalline structure expressed by general formula Li_{X}MnₐCo_{b}O₂(where X is a value of 0.9 or greater but not greater than 1.1, a is a value of 0.45 or greater but not greater than 0.55, b is a value of 0.45 or greater but not greater than 0.55, and the sum of a and b is greater than 0.9 but not greater than 1.1), together with either of a lithium cobalt oxide and a spinel-type lithium manganate; a negative electrode containing a negative electrode active material capable of intercalating and deintercalating lithium ions; a separator separating the positive electrode and the negative electrode; and a non-aqueous electrolyte.

### BACKGROUND OF THE INVENTION

1. Field of the Invention

The present invention relates to a non-aqueous electrolyte secondary battery comprising a positive electrode containing a positive electrode active material capable of intercalating and deintercalating lithium ions, a a negative electrode containing a negative electrode active material capable of intercalating and deintercalating lithium ions, a separator between the positive electrode and the negative electrode negative electrode, and a non-aqueous electrolyte.

2. Description of the Related Art

As lightweight and high capacity rechargeable batteries for use in portable electronic and telecommunication devices and the like such as compact video cameras, cellular phones, and portable personal computers, recently put into practical use are non-aqueous electrolyte secondary batteries, which employ an alloy or a carbon material capable of intercalating and deintercalating lithium ions as the negative electrode active material and a lithium-containing transition complex oxide such as a lithium cobalt oxide (LiCoO₂), a lithium nickel oxide (LiNiO₂), or a lithium manganese oxide (LiMn₂O₄) as the positive electrode material.

Among the lithium-containing composite oxides described above for use as a positive electrode material of a non-aqueous electrolyte secondary battery, lithium nickel oxide (LiNiO₂) yields a high battery capacity, however, it was found have disadvantages as such that it was low in safety and that it yield a low discharge operation voltage. Hence, there was a problem as such that it was inferior to lithium cobalt oxide (LiCoO₂). In case of lithium manganate (LiMn₂O₄), it is characterized in that it abounds in resources, that is inexpensive, and that shows superior safety. However, there was a problem as such that it was inferior to lithium cobalt oxide (LiCoO₂) in that it had disadvantages as such that it yielded low energy density and that manganese itself undergoes dissolution. In this context, at present, lithium cobalt oxide (LiCoO₂) is mainly used as the lithium-containing complex oxide.

Recently, study has been made on novel positive electrode active materials such as an olivine-type LiMPO₄ (where, M represents Fe, Co, and the like) and a 5-V class LiNi_{0.5}Mn_{1.5}O₄, and these have attracted attention as a positive electrode active material for non-aqueous electrolyte secondary battery of next generation. However, since these positive electrode active materials yield discharge operation voltage as high as in a range of 4 to 5 V, they exceed the withstand voltage (decomposition voltage) of the organic electrolyte currently used in the non-aqueous electrolyte secondary battery. This increases the cycle degradation with repeated charging and discharging, and requires optimization of the organic electrolyte and the other materials constituting the cell. Hence, there occurred a problem of consuming long time for putting this type of battery to practical use.

On the other hand, there is proposed a 3-V class lithium-manganese complex oxide having a layered structure. The lithium-manganese complex oxide having a layered structure is yields a large discharge capacity, however, it tends to show the discharge operation voltage in two stages, namely, in the 4-V region and the 3-V region, and it suffers a problematically large cycle degradation. Furthermore, since this material mainly discharges in the 3-V region, it was found difficult to use it in direct replacement for the non-aqueous electrolyte secondary battery using lithium cobalt oxide having the discharge region in the 4-V region and currently employed in practical use.

In the light of the aforementioned circumstances, a Li—Ni—Mn based complex oxide (LiNi_{0.5}Mn_{0.5}O₂) having a layered structure is being proposed. The Li—Ni—Mn based complex oxide (LiNi_{0.5}Mn_{0.5}O₂) having a layered structure exhibits a excellent characteristics as a novel positive electrode active material as such to yield a plateau in the 4-V region and a relatively high discharge capacity per unit mass in the region of from 140 to 150 mAh/g. Hence, it was found promising as one of positive electrode active materials for a novel non-aqueous electrolyte secondary battery.

However, the positive electrode active material such a (LiNi_{0.5}Mn_{0.5}O₂) was found to yield a low initial charge discharge efficiency in a range of from 80 to 90%, to show relatively low discharge operation voltage similar to that of lithium-containing nickel oxide, and to have poor cycle characteristics as compared with lithium cobalt oxide. That is, there was a problem that the material requires more improvement in characteristics due to its large inheritance of the characteristics of a nickel based lithium-containing complex material.

On the other hand, a lithium secondary battery being improved in the high temperature characteristics was proposed in JP-A-2001-23617, in which a 3-V class lithium-manganese complex oxide (LiMnO₂) having a layered structure and partially substituted by Al, Fe, Co, Ni, Mg, Cr, etc., expressed by LiₓMn_{Y}M_{1-Y}O₂ (where, X is greater than 0 but not greater than 1.1, and Y is 0.5 or greater but not greater than 1.0) was used. However, the lithium secondary battery proposed in JP-A-2001-23617 suffered a problem as such that it cannot directly substitute it in usages employing lithium cobalt oxide using the 4-V region for the cat., because LiₓMn_{Y}M_{1-Y}O₂ was found to yield a lower discharge voltage.

Furthermore, in JP-A-1997-293538 is proposed adding lithium cobalt oxide (LiCoO₂) or lithium nickel oxide (LiNiO₂) in lithium manganate (LiMn₂O₄) to improve the safety of lithium manganate (LiMn₂O₄), thereby improving the low energy density. However, the method proposed in Japanese Patent Laid-Open No. 293538/1997 was found to yield a still low energy density in the mixing region capable of taking advantage of the safety of lithium manganate (LiMn₂O₄), and to be unable to sufficiently improve the disadvantages of each of the active materials.

### SUMMARY OF THE INVENTION

The present invention has been made to overcome the problems above, and an object thereof is to provide a non-aqueous electrolyte secondary battery having a plateau in voltage in the 4-V region well comparable to that of lithium cobalt oxide, a high energy density, and cell characteristics such as safety, cycle properties, and high temperature storage properties.

In order to achieve the objects above, the non-aqueous electrolyte secondary battery according to the present invention comprises a positive electrode containing a positive electrode active material admixed therein a lithium-containing complex oxide having a layered crystalline structure expressed by general formula Li_{X}MnₐCo_{b}O₂(where X is a value of 0.9 or greater but not greater than 1.1, a is a value of 0.45 or greater but not greater than 0.55, b is a value of 0.45 or greater but not greater than 0.55, and the sum of a and b is greater than 0.9 but not greater than 1.1), together with either of a lithium cobalt oxide and a spinel-type lithium manganate; a negative electrode containing a negative electrode active material capable of intercalating and deintercalating lithium ions; a separator separating the positive electrode and the negative electrode; and a non-aqueous electrolyte.

In the Li—Mn—Co based complex oxide (lithium-containing complex oxide) expressed by general formula Li_{X}MnₐCo_{b}O₂ has values for a and b in the range of from 0.45 to 0.55 (i.e., when a is a value of 0.45 or greater but not greater than 0.55, b is a value of 0.45 or greater but not greater than 0.55), the layered structure is a single phase with an α-NaFeO₂ type crystal structure (monoclinic structure), and no peaks assigned to LiCoO₂ or Li₂MnO₃ are observed. Hence, a flat discharge curve is obtained. On the other hand, in case values of a and b exceed the range of from 0.45 to 0.55, crystal structure comprising two or more phases develops as to yield peaks assigned to LiCoO₂ or Li₂MnO₃, and the discharge curve shows splitting into two stages from the final stage of the discharge. Furthermore, experimental results indicated that the discharge capacity, discharge operation voltage, and initial charge discharge efficiency improve in case a and b values fell in a range of from 0.45 to 0.55.

Accordingly, synthesis of the lithium-containing complex oxide expressed should be performed as such that, in the general formula Li_{X}MnₐCo_{b}O₂, a is a value of 0.45 or greater but not greater than 0.55 and b is a value of 0.45 or greater but not greater than 0.55. In this case, the compound having the layered crystalline structure does not have so many sites at which the lithium ions can be intercalated and discharged in the interlayer as compared with the case of a spinel-type lithium manganate. Since lithium ions are intercalated and discharged at the interlayer, the x value of the positive electrode active material expressed by Li_{X}MnₐCo_{b}O₂ is limited to about 1.1. Furthermore, since the lithium source on fabricating the cell is only the positive electrode active material at the stage of synthesizing the positive electrode active material, the value of x must be 0.9 or higher. Accordingly, the synthesis is preferably performed as such that the value of x should fall in a range of 0.9 or higher but not higher than 1.1.

In a non-aqueous electrolyte secondary battery using a mixed positive electrode active material comprising a Li—Mn—Co based complex oxide (Li_{X}MnₐCo_{b}O₂) containing added therein lithium cobalt oxide (LiCoO₂), it has been found that the discharge capacity increases with increasing amount of added lithium cobalt oxide, that a high initial charge and discharge efficiency is obtained, and that the discharge operation voltage is well comparable to that using lithium cobalt oxide alone. Hence, the mixed positive electrode active material was found that it can sufficiently replace lithium cobalt oxide. Furthermore, in case of a non-aqueous electrolyte secondary battery using a mixed positive electrode active material comprising a Li—Mn—Co based complex oxide containing added therein a spinel-type lithium manganate (LiMn2O 4), it has been found that, although the discharge capacity decreases with increasing amount of added spinel-type lithium manganate, the initial charge and discharge efficiency is high, and that a discharge operation voltage well comparable to the case of lithium cobalt oxide alone. In this case again, the mixed positive electrode active material was found that it can sufficiently replace lithium cobalt oxide.

The mixed positive electrode active material comprising a Li—Mn—Co based complex oxide containing added therein lithium cobalt oxide was found to yield a higher discharge capacity as compared with Li—Mn—Co based complex oxide, and the mixed positive electrode active material comprising a Li—Mn—Co based complex oxide containing added therein spinel-type lithium manganate was found to yield a higher discharge capacity as compared with spinel-type lithium manganate. Thus, it can be understood that the mixed positive electrode active materials are more favorable. Furthermore, it has been found that, in the non-aqueous electrolyte secondary battery employing a Li—Mn—Co based complex oxide added therein lithium cobalt oxide (LiCoO₂), the capacity retention ratio and the capacity recovery ratio are greatly improved as compared with the case of a non-aqueous electrolyte secondary battery using the Li—Mn—Co based complex oxide alone. In particular, the problematic gas generation attributed to the decomposition of the electrolyte upon storage at high temperatures was found to greatly decrease with increasing amount of added lithium cobalt oxide; in case the amount of added lithium cobalt oxide is increased to 40 wt. % or more, the amount of gas generated was found to be suppressed to a level comparable to that of a non-aqueous electrolyte secondary battery using lithium cobalt oxide (LiCoO₂) alone.

The above findings is believed ascribed to the fact that the oxidation of the Li—Mn—Co based complex oxide is suppressed by mixing lithium cobalt oxide, and, although the details is yet to be clarified, some kind of synergetic effect is exhibited. Furthermore, it has been found that the discharge capacity increases with increasing amount of added lithium cobalt oxide, and that the gas generation is greatly decreased as the amount of added lithium cobalt oxide increases to 40 wt. % or higher. From the fact above, it can be understood that the amount of adding lithium cobalt oxide is preferably 40 wt. % or higher.

On the other hand, in the case of a non-aqueous electrolyte secondary battery comprising a Li—Mn—Co based complex oxide added therein a spinel-type lithium manganate (LiMn₂O₄), the capacity retention ratio on storage high temperatures is greatly improved as compared with a non-aqueous electrolyte secondary battery using the Li—Mn—Co based complex oxide alone; however, the capacity retention ratio and the capacity recovery ratio at storage after finishing charging were found to be greatly decreased. In particular, the problematic gas generation attributed to the decomposition of the electrolyte on storage at high temperatures was found to be increased with increasing amount of adding the spinel-type lithium manganate, and as the added amount of spinel-type lithium manganate became as high as 40 wt. % or more, the amount of gas generated was found to be about the same as that of a non-aqueous electrolyte secondary battery utilizing the spinel-type lithium manganate alone.

The findings above is believed ascribed to the fact that the oxidizability of the Li—Mn—Co based complex oxide increases by mixing lithium manganese oxide, and, although the details is yet to be clarified, anode is damaged by the dissolution of manganese. In this manner, the discharge capacity decreases with increasing amount of added spinel-type lithium manganate, and as the amount of spinel-type lithium manganate decreases to lower than 40 wt. %, the gas generation lowers. Hence, the amount of added spinel-type lithium manganate is preferably less than 40 wt. %.

From the results above, it can be understood that lithium-containing complex oxide and lithium cobalt oxide are admixed in such a manner that the ratio B/(A+B) fall in a range of 0.4 or greater but less than 1.0, where A represents the mass of the lithium-containing complex oxide and B represents the mass of lithium cobalt oxide. Furthermore, it can be also understood that it is preferred that lithium-containing complex oxide and spinel-type lithium manganate are admixed in such a manner that the ratio C/(A+C) fall in a range greater than 0 but less than 0.4, where A represents the mass of the lithium-containing complex oxide and C represents the mass of spinel-type lithium manganate.

Further, by adding a foreign element (M=Al, Mg, Sn, Ti, Zr) to the Li—Mn—Co based complex oxide, and by substituting a part of the complex oxide with a foreign element (M=Al, Mg, Sn, Ti, Zr) to obtain Li_{X}MnₐCo_{b}M_{c}O₂ (M=Al, Mg, Sn, Ti, Zr), it has been found that the capacity retention ratio after storage at high temperatures can be increased. By thus substituting a part of Li—Mn—Co based complex oxide with a foreign element (M) such as Al, Mg, Sn, Ti, or Zr, it is believed that the crystallinity of the layered structure is stabilized.

In case the compositional ratio (amount of substitution) of the foreign element such as Al, Mg, Sn, Ti, or Zr exceeds 0.05 (i.e., c=0.05), the crystal structure tends to show two or more phases. In case the amount of substitution becomes to large, difficulty is found to maintain the crystallographic morphology, and the capacity retention ratio and the initial charge and discharge efficiency after storage tends to decrease. From these facts, the compositional ratio (amount of substitution) of the foreign element such as Al, Mg, Sn, Ti, or Zr should be set to 0.05 or lower (i.e., 0<c≦0.05). Studies have been made on Ni, Ca, Fe, and the like as other foreign elements; however, no effect was observed on increasing the capacity retention ratio after storage at high temperatures.

From the results above, a substituted Li—Mn—Co type complex oxide (i.e., a substituted lithium-containing complex oxide) expressed by the general formula should be synthesized in such a manner that X is a value of 0.9 or greater but not greater than 1.1, a is a value of 0.45 or greater but not greater than 0.55, b is a value of 0.45 or greater but not greater than 0.55, and the sum of a and b is greater than 0.9 but not greater than 1.1, and that the foreign element (M) should be selected from one of Al, Mg, Sn, Ti, and Zr.

Furthermore, in case the value of a+b+c fall in a range of from 0.90 to 1.1 in the substituted Li—Mn—Co based complex oxide expressed by the general formula Li_{X}MnₐCo_{b}M_{c}O₂, it has been found that the layered crystal structure can be maintained. On the other hand, in case the value of a+b+c should fall outside the range of from 0.90 to 1.10, peaks assigned to LiCoO₂ or Li₂MnO₃ become discernible in the X-ray diffraction pattern. Hence, it can be understood that a mixture of two or more phases differing in crystal structure. Thus, the substituted Li—Mn—Co based complex oxide expressed by the general formula Li_{X}MnₐCo_{b}M_{c}O₂ should be prepared in such a manner that the value of a+b+c is greater than 0.90 but not greater than 1.10. Concerning the compositional ratio a and b, the discharge capacity can be increased by setting the ratio a/b in a range of 0.9 or greater but smaller than 1.1. Hence, the synthesis is preferably performed in such a manner that the compositional ratio a/b should fall in a range of 0.9 or greater but smaller than 1.1.

### BRIEF DESCRIPTION OF THE DRAWINGS

FIG. 1 is a diagram showing the relation between the amount of added lithium cobalt oxide (LiCoO₂) in a Li—Mn—Co based complex oxide (LiₓMnₐCo_{b}O₂) and the discharge capacity or the cell expansion ratio.

FIG. 2 is a diagram showing the relation between the amount of added spinel-type lithium manganate (LiMn₂O₄) in a Li—Mn—Co based complex oxide (LiₓMnₐCo_{b}O₂) and the discharge capacity or the cell expansion ratio.

FIG. 3 is a diagram showing the relation between the charge and discharge cycles and the capacity retention ratio for different types of positive electrode active materials.

### DESCRIPTION OF THE PREFERRED EMBODIMENTS

The embodiment of carrying out the present invention is described below, but the invention is not only limited thereto, and proper modifications can be made so long as the object of the invention is achieved.

1. Preparation of Positive Electrode Active Material

After dissolving each of lithium hydroxide, manganese oxide, and cobalt oxide in caustic soda, the resulting products were prepared and mixed in such a manner that their molar ratio as reduced to hydroxides would be 2:1:1. Then, after half burning the products at a temperature as low as about 500° C., they were calcined under air in the temperature range of from 800 to 1000° C. to obtain a Li—Mn—Co based complex oxide (LiMn_{0.50}Co_{0.50}O₂) as the positive electrode active material α.

2. Preparation of Mixed Positive Electrode

### (1) EXAMPLE 1

A mixed positive electrode active material was prepared by mixing the positive electrode active material α thus prepared above with lithium cobalt oxide expressed by LiCoO₂ at a mass ratio of 80:20, and a carbon electrically conductive agent was admixed with the mixed positive electrode active material at a predetermined ratio (for instance, 92:5 by mass ratio). Thus was obtained a powder of mixed positive electrode blend agent.

Then, the powder of mixed positive electrode blend agent was fed inside a mixing apparatus (for example, Hosokawa AM-15F mechanofusion system). The apparatus was revolved at 1500 revolutions per minute (1500 rpm) for 10 minutes to mix the powder by applying compression, impact, and shearing action. The powder of mixed positive electrode blend agent was mixed with a fluororesin binder at a predetermined ratio (e.g., 97:3 by mass ratio) to obtain a positive electrode blend agent. The positive electrode blend agent thus obtained was coated and adhered to the both sides of a positive electrode collector made of aluminum foil, and after drying, the product was rolled to a predetermined thickness to obtain a mixed positive electrode. The mixed positive electrode thus produced was denoted as positive electrode al of Example 1.

### (2) EXAMPLES 2 to 4

Mixed positive electrode was produced in a manner similar to that described in Example 1 above, except for preparing a mixed positive electrode active material by mixing the positive electrode active material α prepared above with lithium cobalt oxide at a mass ratio of 60:40. Thus was obtained a positive electrode a2 of Example 2. Similarly, another mixed positive electrode was produced in a manner similar to that described in Example 1 above, except for preparing the mixed positive electrode active material by mixing the positive electrode active material α and lithium cobalt oxide at a mass ratio of 40:60. Thus was obtained a positive electrode a3 of Example 3. Further similarly, a still other mixed positive electrode was produced in a manner similar to that described in Example 1 above, except for preparing the mixed positive electrode active material by mixing the positive electrode active material α and lithium cobalt oxide at a mass ratio of 20:80. Thus was obtained a positive electrode a4 of Example 4.

### (3) EXAMPLES 5 to 8

A mixed positive electrode active material was prepared by mixing the positive electrode active material α prepared above with a spinel-type lithium manganate expressed by LiMn₂O₄ at a mass ratio of 80:20, and a carbon electrically conductive agent was admixed with the mixed positive electrode active material at a predetermined ratio (for instance, 92:5 by mass ratio). Thus was obtained a powder of mixed positive electrode blend agent. Subsequently, a mixed positive electrode was produced in a manner similar to that described in Example 1 to obtain a positive electrode b1 of Example 5.

Similarly, a mixed positive electrode was produced in a manner similar to that described in Example 5 above, except for preparing a mixed positive electrode active material by mixing the positive electrode active material α with spinel-type lithium manganate at a mass ratio of 60:40. Thus was obtained a positive electrode b2 of Example 6. Further similarly, a mixed positive electrode was produced in a manner similar to that described in Example 5 above, except for preparing a mixed positive electrode active material by mixing the positive electrode active material α with spinel-type lithium manganate at a mass ratio of 40:60. Thus was obtained a positive electrode b3 of Example 7. Also, a mixed positive electrode was produced in a manner similar to that described in Example 5 above, except for preparing a mixed positive electrode active material by mixing the positive electrode active material α with spinel-type lithium manganate at a mass ratio of 20:80. Thus was obtained a positive electrode b4 of Example 8.

### (4) COMPARATIVE EXAMPLE 1

A powder of positive electrode blend agent was prepared by mixing the positive electrode active material α prepared above with a carbon electrically conductive agent at a predetermined ratio (for instance, 92:5 by mass ratio). Then, after mixing the powder of positive electrode blend agent in a manner similar to that described above, a fluororesin binder was mixed therewith at a predetermined ratio (for instance, 97:3 by mass ratio) to obtain a positive electrode blend agent. The positive electrode blend agent thus obtained was coated and adhered to both sides of a positive electrode collector made of aluminum foil, and after drying, the product was rolled to a predetermined thickness to obtain a positive electrode. The positive electrode thus produced was denoted as positive electrode x1 of Comparative Example 1.

### (5) COMPARATIVE EXAMPLE 2

Lithium cobalt oxide expressed by LiCoO₂ was admixed with a carbon electrically conductive agent at a predetermined ratio (for instance, 92:5 by mass ratio) to obtain a powder of positive electrode blend. Then, after mixing the powder of positive electrode blend agent in a manner similar to that described above, a fluororesin binder was mixed therewith at a predetermined ratio (for instance, 97:3 by mass ratio) to obtain a positive electrode blend agent. The positive electrode blend agent thus obtained was coated and adhered to both sides of a positive electrode collector made of aluminum foil, and after drying, the product was rolled to a predetermined thickness to obtain a positive electrode. The positive electrode thus produced was denoted as positive electrode x2 of Comparative Example 2.

### (6) COMPARATIVE EXAMPLE 3

A spinel-type lithium manganate expressed by LiMn₂O₄ was admixed with a carbon electrically conductive agent at a predetermined ratio (for instance, 92:5 by mass ratio) to obtain a powder of positive electrode blend. Then, after mixing the powder of positive electrode blend agent in a manner similar to that described above, a fluororesin binder was mixed therewith at a predetermined ratio (for instance, 97:3 by mass ratio) to obtain a positive electrode blend agent. The positive electrode blend agent thus obtained was coated and adhered to both sides of a positive electrode collector made of aluminum foil, and after drying, the product was rolled to a predetermined thickness to obtain a positive electrode. The positive electrode thus produced was denoted as positive electrode x3 of Comparative Example 3.

3. Production of a Non-Aqueous Electrolyte Secondary Battery

A negative electrode active material capable of intercalating and deintercalating lithium ions was mixed with a styrene-based binder at a predetermined ratio (for instance, 98:2 by mass ratio), and after adding water and mixing to obtain a negative electrode blend agent, the negative electrode blend agent was coated and adhered to both sides of a negative electrode collector made of copper foil. By rolling, a negative electrode was produced. As the negative electrode active material, preferably used is, for instance, graphite, carbon black, coke, glassy carbon, carbon fibers, and calcined bodies thereof. Furthermore, there may be used oxides capable of intercalating and deintercalating lithium, such as tin oxide or titanium oxide.

Then, leads were each attached to each of the positive electrodes a1 to a4, b1 to b4, and x1 to x3 produced in the manner above; at the same time, a lead was attached to the negative electrode thus produced, and each of the positive electrodes and the negative electrode were wound into a coil with a polypropylene separator interposed between them to obtain each as a coiled electrode body. Each of the coiled electrode body was inserted into a cell outer casing, and the leads were connected to the positive electrode terminal or to the negative electrode terminal. Then, an electrolyte obtained by dissolving LiPF₆ into a mixed solvent comprising a 3:7 (by volume) mixture of ethylene carbonate and diethyl carbonate was injected into the outer casing, and the casing was sealed to obtain each of the non-aqueous electrolyte secondary batteries having a capacity of 500 mAh. Thus were obtained non-aqueous electrolyte secondary batteries A1 to A4, B1 to B4, and X1 to X3. The shape of the batteries might be of a thin type, a square, a cylinder, or of any shape. Furthermore, there are no particular limitations concerning their size.

In the non-aqueous electrolyte secondary batteries above, those obtained by using positive electrodes a1 to a4 were denoted cells A1 to A4, those obtained from positive electrodes b1 to b4 were denoted cells B1 to B4, and those obtained from positive electrodes x1 to x3 were denoted cells X1 to X3. The electrolyte is not limited to the example described above, and as Li salt (electrolyte salt), preferred are, for instance, LiClO₄, LiBF₄, LiN(SO₂CF₃)₂, LiN(SO₂C₂F₅)₂, or LiPF_{6-X}(CₙF₂ₙ₊₁)_{X} (where, X is value 1 or greater but not greater than 6, and n is 1 or 2), and one type selected among them, or two types or more thereof may be used in mixture. The concentration of the electrolyte salt is not particularly limited, however, it preferably is in a range of from 0.2 to 1.5 mol per 1 liter of the electrolyte solution (0.2 to 1.5 mol/l).

As the solvent, preferred for use are, for example, propylene carbonate, ethylene carbonate, butylene carbonate, dimethyl carbonate, diethyl carbonate, ethyl methyl carbonate, or γ-butyrolactone, in which one type or two or more types may be used as a mixture. Among them, preferred are the carbonate-based solvents, and also preferred is to use a cyclic carbonate and an acyclic carbonate in mixture. As the cyclic carbonate, preferred is propylene carbonate or ethylene carbonate, and as the acyclic carbonate, preferred is dimethyl carbonate, diethyl carbonate, or ethyl methyl carbonate.

5. Measurements

(1) Measurement of Discharge Capacity and Initial Charge and Discharge Efficiency

Subsequently, each of the positive electrodes a1 to a4, b1 to b4, and x1 to x3 thus produced above, as well as lithium metallic plates as their counter electrodes and reference electrodes, were placed in an open type electrolytic cell. Then, an electrolyte solution prepared by dissolving LiPF₆ into a mixed solvent comprising a 3:7 (by volume) mixture of ethylene carbonate and diethyl carbonate was injected into the electrolytic cell to fabricate an open-type simple cell. The simple cell thus obtained was charged under a room temperature to a voltage of 4.3 V with respect to the counter electrode, and was then discharged to 2.85 V to obtain the discharge capacity from the time of discharge. After the test, the discharge capacity per 1 g of the active material (mAh/g) for each of the positive electrodes a1 to a4, b1 to b4, and x1 to x3 was calculated to obtain results as shown in Table 1. Furthermore, the initial charge and discharge efficiency was calculated according to equation (1) below to obtain results as shown in Table 1.

Initial charge and discharge efficiency (%)=(discharge capacity/charge capacity)×100−(1)

TABLE 1

| | Material added to | | | Initial charge |
|---|---|---|---|---|
| Type of | LiMn_{0.50}Co_{0.50}O₂ | | Discharge | discharge |
| positive | | Amount | capacity | efficiency |
| electrode | Type | added (wt. %) | (mAh/g) | (%) |
| a1 | LiCoO₂ | 20 | 148.4 | 96.4 |
| a2 | LiCoO₂ | 40 | 151.0 | 96.3 |
| a3 | LiCoO₂ | 60 | 154.1 | 96.6 |
| a4 | LiCoO₂ | 80 | 157.5 | 96.4 |
| b1 | LiMn₂O₄ | 20 | 140.1 | 96.5 |
| b2 | LiMn₂O₄ | 40 | 134.7 | 96.3 |
| b3 | LiMn₂O₄ | 60 | 128.9 | 96.5 |
| b4 | LiMn₂O₄ | 80 | 124.3 | 96.4 |
| x1 | None | 0 | 145.2 | 96.3 |
| x2 | LiCoO₂ | 100 | 160.3 | 96.5 |
| x3 | LiMn₂O₄ | 100 | 118.2 | 96.6 |

It can be clearly understood from the results shown in Table 1 above that, the discharge capacity of battery X1 using the Li—Mn—Co based complex oxide (LiMn_{0.50}Co_{0.50}O₂) alone as the positive electrode active material yields a discharge capacity of about 145 mAh/g, the discharge capacity of battery X2 using lithium cobalt oxide (LiCoO₂) as the positive electrode active material yields a discharge capacity of about 160 mAh/g, and the discharge capacity of battery X3 using spinel-type lithium manganate (LiMn₂O₄) as the positive electrode active material yields a discharge capacity of about 118 mAh/g. Thus, it can be seen that the discharge capacity is larger for the battery X2 using lithium cobalt oxide (LiCoO₂) as the positive electrode active material, that the discharge capacity is smaller for the battery X3 using spinel-type lithium manganate (LiMn₂O₄) as the positive electrode active material, and that the discharge capacity for the battery X1 using the Li—Mn—Co based complex oxide (LiMn_{0.50}Co_{0.50}O₂) alone as the positive electrode active material yields an intermediate discharge capacity between the former two.

On the other hand, in the batteries A1 to A4 using lithium cobalt oxide (LiCoO₂) in addition to the Li—Mn—Co based complex oxide (LiMn_{0.50}Co_{0.50}O₂) as the mixed positive electrode active material, it can be seen that the discharge capacity increases with increasing amount of addition of lithium cobalt oxide, that the initial charge and discharge efficiency is about 96%, and that the discharge operation voltage is equivalent to that using lithium cobalt oxide alone. Hence, it can be understood that these mixed positive electrode materials can sufficiently replace lithium cobalt oxide. Furthermore, in the batteries B1 to B4 using spinel-type lithium manganate (LiMn₂O₄) in addition to the Li—Mn—Co based complex oxide (LiMn_{0.50}Co_{0.50}O₂) as the mixed positive electrode active material, it can be seen that the discharge capacity decreases with increasing amount of addition of spinel-type lithium manganate, but that the initial charge and discharge efficiency is about 96%, and that the discharge operation voltage is equivalent to that using lithium cobalt oxide alone. Hence, it can be understood that these mixed positive electrode materials can sufficiently replace lithium cobalt oxide.

Further, it can be said that the mixed positive electrode material obtained by adding lithium cobalt oxide to the Li—Mn—Co based complex oxide (LiMn_{0.50}Co_{0.50}O₂) is preferred because it yields a higher discharge capacity than that of the Li—Mn—Co based complex oxide, and that the mixed positive electrode material obtained by adding spinel-type lithium manganate to the Li—Mn—Co based complex oxide (LiMn_{0.50}Co_{0.50}O₂) is preferred because it yields a higher discharge capacity than that of the spinel-type lithium manganate.

(2) Measurement of Capacity Retention Ratio

Each of the batteries A1 to A4, B1 to B4, and X1 to X3, was charged to a voltage of 4.2 V at a charge current of 500 mA (1 It) under an atmosphere kept at room temperature (about 25° C.), and on reaching 4.2 V, charging was performed at a constant voltage of 4.2 V until the charge current fell to 25 mA or lower. After stopping for 10 minutes, discharging was performed at a charge current of 500 mA (1 It) until the discharge final voltage became 2.75 V. Thus, a cycle test comprising a step of 4.2 V-500 mA constant current-constant voltage charging and a step of 500 mA constant current discharging as 1 cycle was repeated, and the discharge capacity after finishing 1 cycle and the discharge capacity after 500 cycles were measured to obtain the capacity retention ratio after 500 cycles (capacity retention ratio (%)=(discharge capacity after 500 cycles/discharge capacity after 1 cycle)×100%) to obtain results as shown in Table 2.

(3) High Temperature Storage Properties After Charging

Each of the batteries A1 to A4, B1 to B4, and X1 to X3, was charged to a voltage of 4.2 V at a charge current of 500 mA (1 It) under an atmosphere kept at room temperature and on reaching 4.2 V, charging was performed at a constant voltage of 4.2 V until the charge current fell to 25 mA or lower. Then, the batteries were each stored for 20 days under an atmosphere kept at 60° C. Then, discharging was performed on each of the batteries A1 to A4, B1 to B4, and X1 to X3, after storage at a charge current of 500 mA (1 It) until the discharge final voltage became 2.75 V. Thus, the discharge capacity after storage was obtained from the discharge time to obtain the ratio with respect to the discharge capacity before storage to calculate the capacity retention ratio (%). The results thus obtained are shown in Table 2. Further, the batteries were charged and discharged again to obtain the recovery discharge capacity from the discharge time, and its ratio with respect to the discharge capacity before storage was calculated to obtain the capacity recovery ratio (%) as shown in Table 2. Furthermore, from the thickness increase ratio (the increase ratio for each of the batteries in the thickness after storage with respect to the thickness before storage) obtained for each of the stored batteries A1 to A4, B1 to B4, and X1 to X3, the battery expansion ratio (maximum value) was calculated to obtain results shown in Table 2 below.

(4) High Temperature Storage Properties After Discharge

Furthermore, each of the batteries A1 to A4, B1 to B4, and X1 to X3, was charged to a voltage of 4.2 V at a charge current of 500 mA (1 It) under an atmosphere kept at room temperature, and on reaching 4.2 V, charging was performed at a constant voltage of 4.2 V until the charge current fell to 25 mA or lower, and was allowed to discharge until the cell voltage fell to 2.75 V. Then, the batteries were each stored for 20 days under an atmosphere kept at 60° C. After storage, each of the batteries A1 to A4, B1 to B4, and X1 to X3, was charged and discharged again to obtain the recovery capacity from the discharge time, and the ratio with respect to the discharge capacity before storage was obtained to calculate the capacity recovery ratio (%). Thus were obtained results as shown in Table 2 below.

Furthermore, from the thickness increase ratio (the increase ratio for each of the batteries in the thickness after storage with respect to the thickness before storage) obtained for each of the stored batteries A1 to A4, B1 to B4, and X1 to X3, the battery expansion ratio (maximum value) was calculated to obtain results shown in Table 2 below.

TABLE 2

| | Capacity | After storage at | | | After storage at | |
|---|---|---|---|---|---|---|
| | retention | finishing charging to 4.2 V | | | finishing discharging to 2.75 V | |
| | ratio | Capacity | Capacity | | Capacity | |
| Type of | after 500 | retention | recovery | Expansion | recovery | Expansion |
| battery | cycles (%) | ratio (%) | ratio (%) | ratio (%) | ratio (%) | ratio (%) |
| A1 | 74.3 | 73.4 | 83.2 | 9.4 | 93.1 | 6.6 |
| A2 | 77.1 | 75.6 | 85.9 | 7.9 | 94.6 | 4.9 |
| A3 | 80.6 | 76.1 | 86.4 | 7.6 | 95.7 | 4.6 |
| A4 | 83.1 | 77.0 | 87.2 | 7.4 | 96.9 | 4.4 |
| B1 | 74.0 | 70.1 | 79.8 | 16.4 | 90.1 | 22.4 |
| B2 | 76.8 | 69.4 | 79.2 | 17.1 | 91.9 | 28.6 |
| B3 | 80.3 | 67.3 | 76.1 | 17.3 | 93.4 | 29.4 |
| B4 | 83.5 | 66.5 | 74.9 | 17.2 | 92.7 | 29.7 |
| X1 | 71.0 | 71.3 | 80.9 | 14.6 | 88.4 | 11.3 |
| X2 | 85.3 | 77.4 | 87.4 | 7.3 | 99.2 | 4.2 |
| X3 | 84.9 | 65.1 | 73.4 | 17.4 | 93.1 | 30.3 |

From the results shown in Table 2, in the batteries A1 to A4 using lithium cobalt oxide (LiCoO₂) in addition to the Li—Mn—Co based complex oxide (LiMn_{0.50}Co_{0.50}O₂) as the mixed positive electrode active material, it can be seen that the capacity retention ratio and the capacity recovery ratio are considerably improved as compared with the case of battery X1 using Li—Mn—Co based complex oxide (LiMn_{0.50}Co_{0.50}O₂) alone. In particular, it can be understood that the gas generation attributed to the decomposition of the electrolyte solution, i.e., the cell expansion ratio, which causes problems in case of high temperature storage, considerably decreases with increasing amount of adding lithium cobalt oxide. Furthermore, it was found that, in case the amount of added lithium cobalt oxide is increased to 40 wt. % or higher, the amount of gas generation can be suppressed to a level well comparable to the case of battery X2 using lithium cobalt oxide (LiCoO₂) alone.

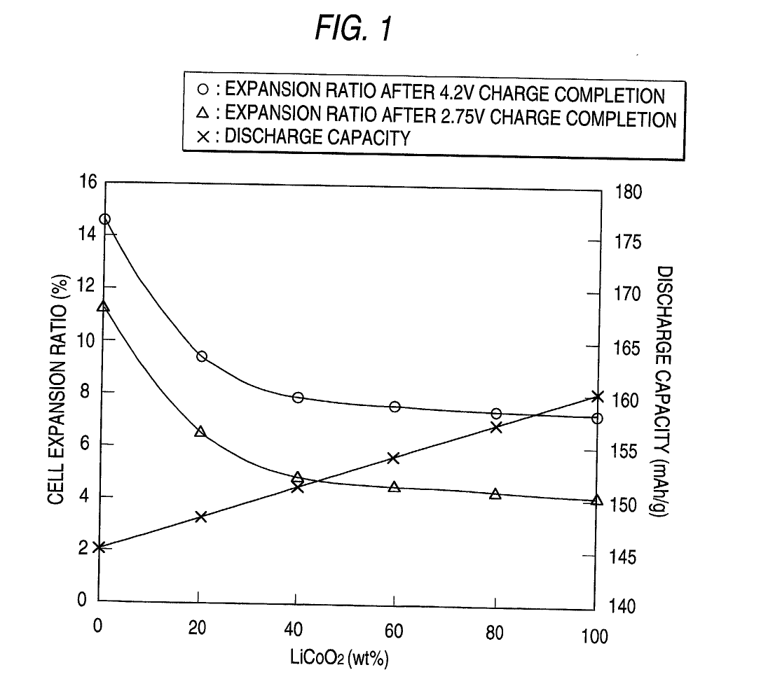

The above findings is believed ascribed to the fact that the oxidation of the Li—Mn—Co based complex oxide is suppressed by mixing lithium cobalt oxide, and, although the details is yet to be clarified, some kind of synergetic effect is exhibited. Thus, the results above were shown in a graph as shown in FIG. 1 by taking the amount of added lithium cobalt oxide as the abscissa and the discharge capacity (mAh/g) and the cell expansion ratio (%) as the ordinate. It can be clearly understood from the results shown in FIG. 1 that the discharge capacity increases with increasing amount of added lithium cobalt oxide, but that it considerably decreases as the amount of added lithium cobalt oxide becomes 40 wt. % or higher. Hence, the amount of added lithium cobalt oxide is preferably set to 40 wt. % or higher.

On the other hand, in the batteries B1 to B4 using spinel-type lithium manganate (LiMn₂O₄) in addition to the Li—Mn—Co based complex oxide (LiMn_{0.50}Co_{0.50}O₂) as the mixed positive electrode active material, it can be seen that the capacity retention ratio after 500 cycles as well as the capacity recovery ratio after storage at 60° C. and 20 days on finishing discharging at 2.75 V are considerably improved as compared with the case of battery X1 using Li—Mn—Co based complex oxide (LiMn_{0.50}Co_{0.50}O₂) alone. However, it can be seen that the capacity retention ratio as well as the capacity recovery ratio after storage at 60° C. and 20 days on finishing charging at 4.2 V are considerably impaired. In particular, it can be understood that the gas generation attributed to the decomposition of the electrolyte solution, i.e., the cell expansion ratio, which causes problems in case of high temperature storage, considerably increases with increasing amount of added spinel-type lithium manganate. Furthermore, it was found that, in case the amount of added spinel-type lithium manganate is increased to 40 wt. % or higher, the cell expansion ratio (the amount of generated gas) increases to a level equivalent to the case of battery X3 using spinel-type lithium manganate alone.

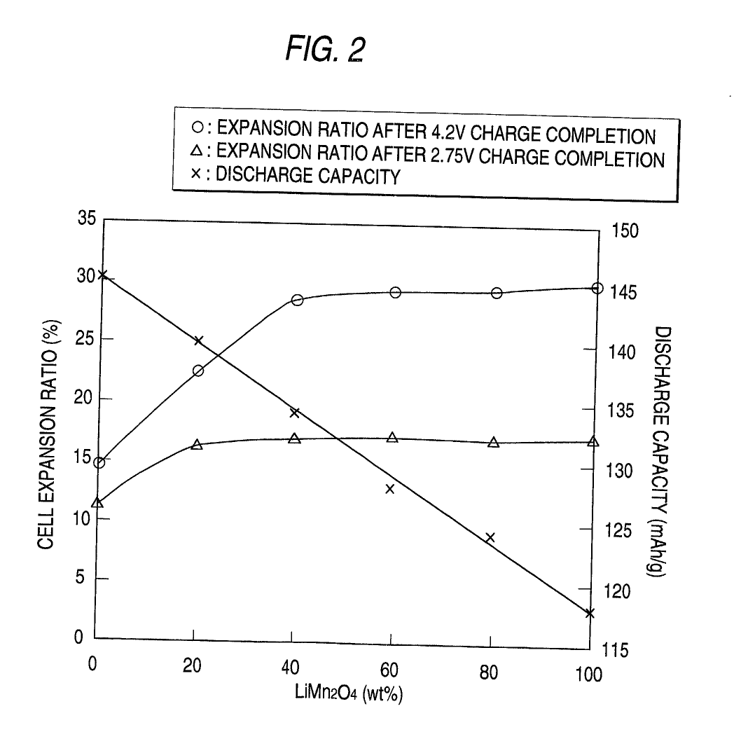

The findings above is believed ascribed to the fact that the oxidizability of the Li—Mn—Co based complex oxide increases by mixing lithium cobalt oxide, and, although the details is yet to be clarified, anode is damaged by the dissolution of manganese. Accordingly, the results above were shown in a graph as shown in FIG. 2 by taking the amount of added spinel-type lithium manganate as the abscissa and the discharge capacity (mAh/g) and the cell expansion ratio (%) as the ordinate. It can be clearly understood from the results shown in FIG. 2 that the discharge capacity decreases with increasing amount of added spinel-type lithium manganate, and that the cell expansion ratio (the amount of generated gas) decreases with decreasing amount of added spinel-type lithium manganate to 40 wt. % or lower. Thus, the amount of added spinel-type lithium manganate is preferably set to 40 wt. % or lower.

By taking the above results into consideration, preferably, the lithium-containing complex oxide and lithium cobalt oxide are admixed in such a manner that the ratio B/(A+B) should be 0.4 or greater but less than 1.0, where A represents the mass of the lithium-containing complex oxide and B represents the mass of lithium cobalt oxide; and preferably, the lithium-containing complex oxide and the spinel-type lithium manganate are admixed in such a manner that the ratio C/(A+C) should be greater than 0 but less than 0.4, where A represents the mass of the lithium-containing complex oxide and C represents the mass of spinel-type lithium manganate.

6. Study on Safety

Subsequently, the safety of the battery was studied on each of the batteries A1 to A4 thus prepared and on X1 and X2. First, each of the batteries A1 to A4 as well as X1 and X2 was charged to a voltage of 4.2 V at a charge current of 1500 mA (3 It) under an atmosphere kept at room temperature (about 25° C.). Then, whether safety valve attached to the batteries operated or not during charging was studied, and the number of batteries was counted. Further, overcharging of the batteries was performed to a voltage of 4.31 V at a charge current of 500 mA (1 It). The resulting batteries were stored under the atmosphere maintained at 160° C. and 170° C. Then, whether safety valve attached to the batteries operated or not during storage was studied, and the number of batteries was counted. The results are given in Table 3 below. The fact that a safety valve operates indicates that the battery is already under an abnormal state. On the contrary, the fact that the safety valve does not operate signifies that the battery is still safe even under the aforementioned conditions. Accordingly, in the overcharging characteristics given in Table 3 and in the thermal characteristics at 160° C. and at 170° C., the divisor represents the number of tested batteries, and the dividend represents the number of (safe) batteries whose safety valve did not operate.

TABLE 3

| | Material added to | | | | |
|---|---|---|---|---|---|
| | LiMn_{0.50}Co_{0.50}O₂ | | | | |
| Type of | | Amount | Overcharging | 160° C. thermal | 170° C. thermal |
| battery | Type | added (wt. %) | characteristics | characteristics | characteristics |
| A1 | LiCoO₂ | 20 | 2/3 | 3/3 | 2/3 |
| A2 | LiCoO₂ | 40 | 2/3 | 3/3 | 2/3 |
| A3 | LiCoO₂ | 60 | 2/3 | 3/3 | 2/3 |
| A4 | LiCoO₂ | 80 | 2/3 | 3/3 | 1/3 |
| X1 | None | 0 | 2/3 | 3/3 | 3/3 |
| X2 | LiCoO₂ | 100 | 1/3 | 2/3 | 0/3 |

The results in Table 3 clearly shows that the battery X1 using Li—Mn—Co based complex oxide (LiMn_{0.50}Co_{0.50}O₂) alone as the positive electrode active material tend to exhibit superior thermal stability as compared with the battery X2 using lithium cobalt oxide (LiCoO₂) alone as the positive electrode active material, and it can be understood that, as compared with the case using lithium cobalt oxide alone, the stability of the battery increases in the case complex positive electrode is used by adding lithium cobalt oxide to the Li—Mn—Co based complex oxide (LiMn_{0.50}Co_{0.50}O₂).

7. Study on the Values a, b, and x of the Complex Oxide Expressed by LiₓMnₐCo_{b}O₂

Subsequently, study has been made on the values a, b, and x of the complex oxide expressed by LiₓMnₐCo_{b}O₂. First, lithium hydroxide, manganese oxide, and cobalt oxide were each dissolved in caustic soda, and the products were mixed after adjusting them in such a manner that they yield a predetermined molar ratio as converted into hydroxides. Then, after half-burning the product at a low temperature of about 500° C., it was calcined under the atmosphere in the temperature range of from 800 to 1000° C. to obtain a lithium-containing complex oxide (LiₓMnₐCo_{b}O₂). In this instance, lithium hydroxide, manganese oxide, and cobalt oxide were prepared in such a manner that the molar ratio as reduced to hydroxide should become 1:0.40 (a=0.40):0.60 (b=0.60). Thus was prepared the Li—Mn—Co complex oxide (LiMn_{0.40}Co_{0.60}O₂), which was denoted as Li—Mn—Co complex oxide φ1 (LiMn_{0.40}Co_{0.60}O₂).

Similarly, Li—Mn—Co complex oxide φ2 (LiMn_{0.45}Co_{0.55}O₂) was prepared by adjusting the ratio to 1:0.45 (a=0.45):0.55 (b=0.55); Li—Mn—Co complex oxide φ3 (LiMn_{0.475}Co_{0.525}O₂) was prepared by adjusting the ratio to 1:0.475 (a=0.475):0.525 (b=0.525); and Li—Mn—Co complex oxide φ4 (LiMn_{0.50}Co_{0.50}O₂) was prepared by adjusting the ratio to 1:0.50 (a=0.50):0.50 (b=0.50). Further, Li—Mn—Co complex oxide φ5 (LiMn_{0.525}Co_{0.475}O₂) was prepared by adjusting the ratio to 1:0.525 (a=0.525):0.475 (b=0.475); Li—Mn—Co complex oxide φ6 (LiMn_{0.55}Co_{0.45}O₂) was prepared by adjusting the ratio to 1:0.55 (a=0.55):0.45 (b=0.45); and Li—Mn—Co complex oxide φ7 (LiMn_{0.60}Co_{0.40}O₂) was prepared by adjusting the ratio to 1:0.60 (a=0.60):0.40 (b=0.40).

On obtaining the X-ray diffraction pattern of the Li—Mn—Co complex oxides φ1 and φ7, peaks assigned to LiCoO₂, Li₂MnO₃ and the like were observed to indicate the product to be a mixture of three phases differing in crystal structure. On the other hand, on obtaining the X-ray diffraction pattern of the Li—Mn—Co complex oxides φ2 to φ6, no peaks assigned to LiCoO₂ and Li₂MnO₃ were observed; hence, it was found to have an α-NaFeO₂ crystal structure (single phase having a layered crystal structure).

Then, each of the Li—Mn—Co complex oxides φ1 to φ7 was mixed with carbon electrically conductive agent and a fluororesin binder at a predetermined ratio (for example, 92:5:3 in mass ratio) to obtain a positive electrode blend agent. The positive electrode blend agent was coated and adhered to both sides of a positive electrode collector made of aluminum foil, dried, and rolled to a predetermined thickness to obtain each of the positive electrodes w1 to w7.

Each of the positive electrodes w1 to w7 prepared above, as well as lithium metallic plates as their counter electrodes and reference electrodes, were placed in an open type electrolytic cell. Then, an electrolyte solution prepared by dissolving LiPF₆ into a mixed solvent comprising a 3:7 (by volume) mixture of ethylene carbonate and diethyl carbonate was injected into the electrolytic cell to fabricate an open-type simple cell. The simple cell thus obtained was charged under a room temperature to a voltage of 4.3 V with respect to the counter electrode, and was then discharged to 2.85 V to obtain the discharge capacity from the time of discharge.

Then, by measuring the discharge voltage with respect to the discharge time upon discharge, the discharge curve as well as the discharge operation voltage was obtained. Furthermore, by calculating the discharge capacity per 1 g (mAh/g) of the active material used in each of the positive electrodes w1 to w7, results as shown in Table 4 were obtained. Then, initial charge and discharge efficiency was obtained in accordance with the equation (1) above to obtain results shown in Table 4 below.

TABLE 4

| | Crystal | | | | | | |
|---|---|---|---|---|---|---|---|
| | structure of the positive | | | | | | |
| Type of | electrode active material | | | Discharge | Operation | Initial charge | |
| positive | | | Crystal | capacity | voltage | and discharge | Discharge |
| electrode | a | b | morphology | (mAh/g) | (V) | efficiency (%) | curve |
| w1 | 0.40 | 0.60 | three phases | 124.9 | 3.59 | 92.8 | two steps |
| w2 | 0.45 | 0.55 | single phase | 140.6 | 3.88 | 96.1 | flat |
| w3 | 0.475 | 0.525 | single phase | 144.9 | 3.89 | 96.0 | flat |
| w4 | 0.50 | 0.50 | single phase | 145.2 | 3.90 | 96.3 | flat |
| w5 | 0.525 | 0.475 | single phase | 144.8 | 3.88 | 96.2 | flat |
| w6 | 0.55 | 0.45 | single phase | 141.3 | 3.87 | 95.9 | flat |
| w7 | 0.60 | 0.40 | three phases | 126.5 | 3.62 | 93.1 | two steps |

From the results shown in Table 4, the following facts were clarified.

More specifically, in case the values a and b for the Li—Mn—Co complex oxide expressed by LiₓMnₐCo_{b}O₂ are in the range of from 0.45 to 0.55, large values can be obtained for the discharge capacity, the discharge operation voltage, and the initial charge and discharge efficiency; furthermore, since the layered crystal structure corresponds to an α-NaFeO₂ type crystalline structure (monoclinic structure) of single phase without any peaks assigned to LiCoO₂ and Li₂MnO₃ present, a flat discharge curve was obtained. On the other hand, in case the values a and b fall out from the range of from 0.45 to 0.55, the values for the discharge capacity, the discharge operation voltage, and the initial charge and discharge efficiency tend to decrease, and peaks attributed to LiCoO₂ and Li₂MnO₃ develop to show a compound having a crystal structure consisting of three phases. The discharge curve tends to develop two steps in the final stages of discharge, probably due to the change in morphology into an orthorhombic system. The decrease in the discharge operation voltage, and the initial charge and discharge efficiency is presumably attributed to the change in crystallographic morphology.

Thus, synthesis should be performed in such a manner that the a and b should yield values in a range of 0.45 or higher but not higher than 0.55. In this case, the compound having the layered crystalline structure does not have so many sites at which the lithium ions can be intercalated and discharged in the interlayer as compared with the case of a spinel-type lithium manganate. Since lithium ions are intercalated and discharged at the interlayer, the x value of the positive electrode active material expressed by Li_{X}MnₐCo_{b}O₂ is limited to about 1.1. Furthermore, since the lithium source on fabricating the cell is only the positive electrode active material at the stage of synthesizing the positive electrode active material, the value of x must be 0.9 or higher. Accordingly, the synthesis is preferably performed as such that the value of x should fall in a range of 0.9 or higher but not higher than 1.1.

8. Study on the Mixed Positive Electrode Using Substituted Type Li—Mn—Co Complex Oxide (LiMnₐCo_{b}M_{c}O₂)

After dissolving each of lithium hydroxide, manganese oxide, and cobalt oxide in caustic soda, the resulting products were prepared and mixed in such a manner that their molar ratio as reduced to hydroxides would be 2:1:1. Then, after adding and mixing titanium oxide to the mixed solution in such a manner that it may account for 0.02 mol. % with respect to the molar ratio of cobalt hydroxide and manganese hydroxide, the resulting product was half burned at a temperature as low as about 500° C. The resulting product was calcined under air in the temperature range of from 800 to 1000° C. to obtain a Li—Mn—Co based complex oxide (LiMn_{0.49}Co_{0.49}Ti_{0.02}O₂) as the positive electrode active material β.

### (1) EXAMPLE 9

A mixed positive electrode active material was prepared by mixing the positive electrode active material β thus prepared above with lithium cobalt oxide (LiCoO₂) at a mass ratio of 80:20, and a carbon electrically conductive agent was admixed with the mixed positive electrode active material at a predetermined ratio (for instance, 92:5 by mass ratio). Thus was obtained a powder of mixed positive electrode blend agent. Then, after mixing the powder of the mixed positive electrode blend agent in a manner similar to above, the powder of mixed positive electrode blend agent was mixed with a fluororesin binder at a predetermined ratio (for instance, 97:3 by mass ratio) to obtain a positive electrode blend agent. The positive electrode blend agent thus obtained was coated and adhered to the both sides of a positive electrode collector made of aluminum foil, and after drying, the product was rolled to a predetermined thickness to obtain a mixed positive electrode. The mixed positive electrode thus produced was denoted as positive electrode c1 of Example 9.

### (2) EXAMPLES 10 to 12

Mixed positive electrode was produced in a manner similar to that described in Example 9 above, except for preparing a mixed positive electrode active material by mixing the positive electrode active material β prepared above with lithium cobalt oxide at a mass ratio of 60:40. Thus was obtained a positive electrode c2 of Example 10. Similarly, another mixed positive electrode was produced in a manner similar to that described in Example 9 above, except for preparing the mixed positive electrode active material by mixing the positive electrode active material β and lithium cobalt oxide at a mass ratio of 40:60. Thus was obtained a positive electrode c3 of Example 11. Further similarly, a still other mixed positive electrode was produced in a manner similar to that described in Example 9 above, except for preparing the mixed positive electrode active material by mixing the positive electrode active material β and lithium cobalt oxide at a mass ratio of 20:80. Thus was obtained a positive electrode c4 of Example 12.

### (3) COMPARATIVE EXAMPLE 4

A powder of positive electrode blend agent was prepared by mixing the positive electrode active material β prepared above with a carbon electrically conductive agent and a fluororesin binder at a predetermined ratio (for instance, 92:5 by mass ratio). Then, after mixing the powder of positive electrode blend agent in a manner similar to that described above, a fluororesin binder was mixed therewith at a predetermined ratio (for instance, 97:3 by mass ratio) to obtain a positive electrode blend agent. The positive electrode blend agent thus obtained was coated and adhered to both sides of a positive electrode collector made of aluminum foil, and after drying, the product was rolled to a predetermined thickness to obtain a positive electrode. The positive electrode thus produced was denoted as positive electrode x4 of Comparative Example 4.

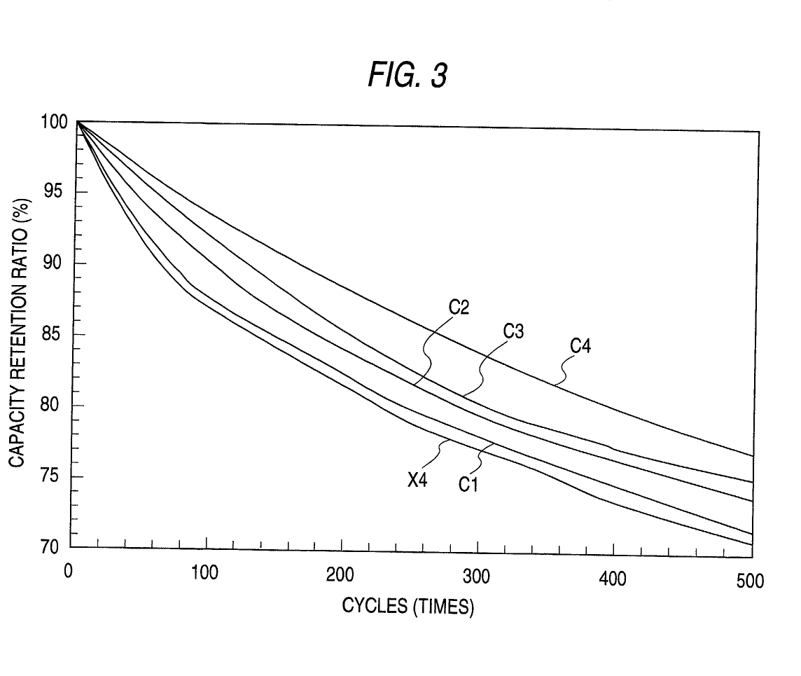

By using each of the positive electrodes c1 to c4 and x4 produced above in combination with the negative electrode described above, non-aqueous electrolyte secondary batteries C1 to C4 and X1 were prepared in a manner similar to that described above. Thereafter, each of the batteries was charged to a voltage of 4.2 V at a charge current of 500 mA (1 It) under an atmosphere kept at room temperature (about 25° C.), and on reaching 4.2 V, charging was performed at a constant voltage of 4.2 V until the charge current fell to 25 mA or lower. After stopping for 10 minutes, discharging was performed at a charge current of 500 mA (1 It) until the discharge final voltage became 2.75 V. Thus, a cycle test comprising a step of 4.2 V-500 mA constant current-constant voltage charging and a step of 500 mA constant current discharging as 1 cycle was repeated, and the discharge capacity after finishing 1 cycle and the discharge capacity after each cycle were measured to obtain the capacity retention ratio after each cycle (capacity retention ratio (%)=(discharge capacity after each cycle/discharge capacity after 1 cycle)×100%) to obtain results as shown in FIG. 3.

From the results shown in FIG. 3, it can be understood that, similar to the case of adding lithium cobalt oxide (LiCoO₂) to the non-substituted type Li—Mn—Co based complex oxide (LiMn_{0.5}Co_{0.5}O₂), the capacity retention ratio increases with increasing the amount of adding lithium cobalt oxide (LiCoO₂) to the substituted type Li—Mn—Co based complex oxide (LiMn_{0.49}Co_{0.49}Ti_{0.02}O₂). On obtaining the capacity retention ratio after 500 cycles, results as shown in Table 5 below were obtained.

Furthermore, each of the batteries C1 to C4 and X1 was charged to a voltage of 4.2 V at a charge current of 500 mA (1 It) under an atmosphere kept at room temperature, and on reaching 4.2 V, charging was performed at a constant voltage of 4.2 V until the charge current fell to 25 mA or lower, and the batteries were each stored for 20 days under an atmosphere kept at 60° C.

After storage, each of the batteries was allowed to discharge until the cell voltage fell to 2.75 V. Thus, the discharge capacity after storage was obtained from the discharge time to obtain the ratio with respect to the discharge capacity before storage to calculate the capacity retention ratio (%). The results are given in Table 5 below. Furthermore, each of the batteries was charged and discharged again to obtain the recovery capacity from the discharge time, and the ratio with respect to the discharge capacity before storage was obtained to calculate the capacity recovery ratio (%). Thus were obtained results as shown in Table 5 below. Furthermore, from the thickness increase ratio (the increase ratio for each of the batteries in the thickness after storage with respect to the thickness before storage) obtained for each of the stored batteries, the battery expansion ratio (maximum value) was calculated to obtain results shown in Table 5 below.

Further, each of the batteries C1 to C4 as well as X4 was charged to a voltage of 4.2 V at a charge current of 500 mA (1 It) under an atmosphere kept at room temperature, and on reaching 4.2 V, charging was performed at a constant voltage of 4.2 V until the charge current fell to 25 mA or lower, and was allowed to discharge until the cell voltage fell to 2.75 V. Then, the batteries were each stored for 20 days under an atmosphere kept at 60° C. After storage, each of the batteries was charged and discharged again to obtain the recovery capacity from the discharge time, and the ratio with respect to the discharge capacity before storage was obtained to calculate the capacity recovery ratio (%). Thus were obtained results as shown in Table 5 below. Furthermore, from the thickness increase ratio (the increase ratio for each of the batteries in the thickness after storage with respect to the thickness before storage) obtained for each of the stored batteries, the battery expansion ratio (maximum value) was calculated to obtain results shown in Table 5 below. In Table 5 below, the result for a battery X2 using a positive electrode active material x2 of Comparative Example 2 is also shown.

TABLE 5

| | Capacity | After storage on | | | After storage on | |
|---|---|---|---|---|---|---|
| | retention | finishing charging to 4.2 V | | | finishing discharging to 2.75 V | |
| | ratio | Capacity | Capacity | | Capacity | |
| Type of | after 500 | retention | recovery | Expansion | recovery | Expansion |
| battery | cycles (%) | ratio (%) | ratio (%) | ratio (%) | ratio (%) | ratio (%) |
| C1 | 81.2 | 75.1 | 87.3 | 8.5 | 92.8 | 6.4 |
| C2 | 82.6 | 76.8 | 87.6 | 7.7 | 93.9 | 4.8 |
| C3 | 83.5 | 77.1 | 87.1 | 7.5 | 95.7 | 4.4 |
| C4 | 84.7 | 77.3 | 87.5 | 7.4 | 97.1 | 4.2 |
| X2 | 85.3 | 77.4 | 87.4 | 7.3 | 99.2 | 4.2 |
| X4 | 80.6 | 74.6 | 86.7 | 11.6 | 91.6 | 10.4 |

On comparing battery X4 with the batteries C1 to C4 shown in Table 5 above, it can be clearly understood that, instead of using the substituted type Li—Mn—Co based complex oxide (LiMn_{0.49}Co_{0.49}Ti_{0.02}O₂) alone, those obtained by adding lithium cobalt oxide (LiCoO₂) yield superior values for the capacity retention ratio after 500 cycles, the capacity retention ratio, capacity recovery ratio, and cell expansion ratio after storage on finishing charging to 4.2 V, as well as the capacity recovery ratio and cell expansion ratio after storage on finishing discharging to 2.75 V. Furthermore, on comparing the case of adding lithium cobalt oxide (LiCoO₂) to the non-substituted type Li—Mn—Co complex oxide (LiMn_{0.5}Co_{0.5}O₂) (see Table 2) with the results obtained in Table 5 above, it can be understood that those obtained by adding lithium cobalt oxide (LiCoO₂) to the substituted type Li—Mn—Co based complex oxide (LiMn_{0.49}Co_{0.49}Ti_{0.02}O₂) yield superior values for the capacity retention ratio after 500 cycles, the capacity retention ratio, capacity recovery ratio, and cell expansion ratio after storage on finishing charging to 4.2 V, as well as the capacity recovery ratio and cell expansion ratio after storage on finishing discharging to 2.75 V. These results are presumably ascribed to the stabilized crystallinity of the layered structure obtained by partially substituting the positive electrode active material with a foreign element (M) such as Al, Mg, Sn, Ti, or Zr.

9. Study on Foreign Elements (M)

After dissolving each of lithium hydroxide, manganese oxide, and cobalt oxide in caustic soda, the resulting products were prepared and mixed in such a manner that the molar ratio for lithium hydroxide, manganese oxide, and cobalt oxide as reduced to hydroxides would be 1:0.49 (a=0.49):0.49 (b=0.49). To the mixed solution thus obtained, an oxide containing the foreign element (M) was added in such a manner that it may account for 0.02 mol % with respect to the molar ratio of cobalt hydroxide and manganese hydroxide. The resulting product was half-burned at a temperature as low as about 500° C. Then, by calcining in the temperature range of from 800 to 1000° C., positive electrode active materials (LiMn_{0.49}Co_{0.49}M_{0.02}O₂) γ, δ, ε, and ζ were obtained.

The positive electrode active materials γ, δ, ε, and ζ thus obtained were mixed with lithium cobalt oxide at a mass ratio of 60:40 to obtain each of the mixed positive electrode active materials, and a carbon electrically conductive agent was admixed with the mixed positive electrode active material at a predetermined ratio (for instance, 92:5 by mass ratio). Thus was obtained a powder of mixed positive electrode blend agent. Then, after mixing the powder of positive electrode blend agent in a manner similar to that described above, a fluororesin binder was mixed therewith at a predetermined ratio (for instance, 97:3 by mass ratio) to obtain a positive electrode blend agent. The positive electrode blend agent thus obtained was coated and adhered to both sides of a positive electrode collector made of aluminum foil, and after drying, the product was rolled to a predetermined thickness to obtain a positive electrode. Thus were produced mixed positive electrodes d, e, f, and g.

By using aluminum (Al) as the foreign element (M), a positive electrode active material γ (LiMn_{0.49}Co_{0.49}Al_{0.02}O₂) for Example 13 was obtained; similarly, a positive electrode active material δ (LiMn_{0.49}Co_{0.49}Mg_{0.02}O₂) for Example 14 was obtained by using magnesium (Mg), a positive electrode active material ε (LiMn_{0.49}Co_{0.49}Sn_{0.02}O₂) for Example 15 was obtained by using tin (Sn), and a positive electrode active material ζ (LiMn_{0.49}Co_{0.49}Zr_{0.02}O₂) for Example 16 was obtained by using zirconium (Zr).

By using each of the positive electrodes d, e, f, and g produced above in combination with the negative electrode described above, non-aqueous electrolyte secondary batteries D, E, F, and G were each prepared in a manner similar to that described above. Thereafter, each of the batteries was charged to a voltage of 4.2 V at a charge current of 500 mA (1 It) under an atmosphere kept at room temperature (about 25° C.), and on reaching 4.2 V, charging was performed at a constant voltage of 4.2 V until the charge current fell to 25 mA or lower. After stopping for 10 minutes, discharging was performed at a charge current of 500 mA (1 It) until the discharge final voltage became 2.75 V. Thus, a cycle test comprising a step of 4.2 V-500 mA constant current-constant voltage charging and a step of 500 mA constant current discharging as 1 cycle was repeated, and the discharge capacity after finishing 500 cycles and the discharge capacity after 500 cycles were measured to obtain the capacity retention ratio after 500 cycles (capacity retention ratio (%)=(discharge capacity after 500 cycles/discharge capacity after 1 cycle)×100%) to obtain results as shown in Table 6 below.

Each of the batteries D, E, F, and G was charged to a voltage of 4.2 V at a charge current of 500 mA (1 It) under an atmosphere kept at room temperature and on reaching 4.2 V, charging was performed at a constant voltage of 4.2 V until the charge current fell to 25 mA or lower. Then, the batteries were each stored for 20 days under an atmosphere kept at 60° C. Subsequently, discharging was performed on each of the batteries after storage at a charge current of 500 mA (1 It) until the discharge final voltage became 2.75 V. Thus, the discharge capacity after storage was obtained from the discharge time to obtain the ratio with respect to the discharge capacity before storage to calculate the capacity retention ratio (%). The results thus obtained are shown in Table 6. Further, the batteries were charged and discharged again to obtain the recovery discharge capacity from the discharge time, and its ratio with respect to the discharge capacity before storage was calculated to obtain the capacity recovery ratio (%) as shown in Table 6. Furthermore, from the thickness increase ratio (the increase ratio for each of the batteries in the thickness after storage with respect to the thickness before storage) obtained for each of the stored batteries, the battery expansion ratio (maximum value) was calculated to obtain results shown in Table 6 below.

Further, each of the batteries D, E, F, and G was charged to a voltage of 4.2 V at a charge current of 500 mA (1 It) under an atmosphere kept at room temperature, and on reaching 4.2 V, charging was performed at a constant voltage of 4.2 V until the charge current fell to 25 mA or lower, and was allowed to discharge until the cell voltage fell to 2.75 V. Then, the batteries were each stored for 20 days under an atmosphere kept at 60° C. After storage, each of the batteries was charged and discharged again to obtain the recovery capacity from the discharge time, and the ratio with respect to the discharge capacity before storage was obtained to calculate the capacity recovery ratio (%). Thus were obtained results as shown in Table 7 below. Furthermore, from the thickness increase ratio (the increase ratio for each of the batteries in the thickness after storage with respect to the thickness before storage) obtained for each of the stored batteries, the battery expansion ratio (maximum value) was calculated to obtain results shown in Table 5 below. In Table 6 below, the results for batteries C2 and A2 are also shown.

TABLE 6

| | | Capacity | After storage on | | | After storage on | |
|---|---|---|---|---|---|---|---|
| | Sub- | retention | finishing charging to 4.2 V | | | finishing discharging to 2.75 V | |
| | stituted | ratio | Capacity | Capacity | | Capacity | |
| Type of | element | after 500 | retention | recovery | Expansion | recovery | Expansion |
| battery | (M) | cycles (%) | ratio (%) | ratio (%) | ratio (%) | ratio (%) | ratio (%) |
| D | Al | 81.9 | 77.2 | 87.5 | 7.4 | 98.9 | 4.3 |
| E | Mg | 83.0 | 77.0 | 87.7 | 7.4 | 99.1 | 4.3 |
| F | Sn | 83.4 | 76.1 | 86.3 | 7.6 | 97.6 | 4.5 |
| G | Zr | 83.7 | 75.9 | 84.7 | 7.6 | 97.1 | 4.6 |
| C2 | Ti | 82.6 | 76.8 | 87.6 | 7.7 | 93.9 | 4.8 |
| A2 | None | 77.1 | 75.6 | 85.9 | 7.9 | 94.6 | 4.9 |

By comparing battery A2 with batteries C2, D, E, F, and G in Table 6 above, it can be clearly understood that, instead of using the non-substituted type Li—Mn—Co based complex oxide (LiMn_{0.5}Co_{0.5}O₂) added therein lithium cobalt oxide (LiCoO₂), those obtained by adding lithium cobalt oxide (LiCoO₂) to the substituted type Li—Mn—Co based complex oxide (LiMn_{0.49}Co_{0.49}Mo_{0.02}O₂) containing a foreign element (M) (i.e., Al, Mg, Sn, Zr, or Ti) yield superior values for the capacity retention ratio after 500 cycles, the capacity retention ratio, capacity recovery ratio, and cell expansion ratio after storage on finishing charging to 4.2 V, as well as the capacity recovery ratio and cell expansion ratio after storage on finishing discharging to 2.75 V. These results are presumably ascribed to the stabilized crystallinity of the layered structure obtained by partially substituting the Li—Mn—Co based complex oxide with a foreign element (M) such as Al, Mg, Sn, Ti, or Zr.

Furthermore, similar tendencies were observed in case of adding a spinel-type lithium manganate (LiMn₂O₄) into a substituted type Li—Mn—Co based complex oxide (LiMn_{0.49}Co_{0.49}M_{0.02}O₂) containing a foreign element (M) (i.e., Al, Mg, Sn, Zr, or Ti) as in the case of admixing lithium cobalt oxide (LiCoO₂).

Moreover, studies were made on other foreign elements such as Ni, Ca, Fe, and the like. However, no effect on improving the capacity retention ratio was observed. This is presumably due to the problems attributed to the crystallographic morphology or the crystal size after substitution. Accordingly, synthesis is preferably made in such a manner that the value of x of the positive electrode active material expressed by the general formula (LiₓMnₐCo_{b}M_{c}O₂) fall in a range of 0.9 or higher but not higher than 1.1, that the values a and b each fall in a range of 0.45 or higher but not higher than 0.55, and that the foreign element (M) is selected from Al, Mg, Sn, Ti, and Zr. In the following, study was made on the amount of adding the foreign element.

10. Study on the Amount of Substitution of Foreign Element (M)

On producing the positive electrode active material β described above, positive electrode active material β1 (LiMn_{0.495}Co_{0.495}Ti_{0.01}O₂) was prepared in such a manner that the ratio x:a:b:c in LiₓMnₐCo_{b}Ti_{c}O₂ should become x:a:b:c=1:0.495:0.495:0.01 (a+b+c=1.00); similarly, positive electrode active material β2 (LiMn_{0.490}Co_{0.490}Ti_{0.02}O₂: the same as β above) was prepared in such a manner that the ratio should become x:a:b:c=1:0.490:0.490:0.02 (a+b+c=1.00); positive electrode active material β3 (LiMn_{0.485}Co_{0.485}Ti_{0.03}O₂) was prepared in such a manner that the ratio should become x:a:b:c=1:0.485:0.485:0.03 (a+b+c=1.00); positive electrode active material β4 (LiMn_{0.475}Co_{0.475}Ti_{0.055}O₂) was prepared in such a manner that the ratio should become x:a:b:c=1:0.475:0.475:0.05 (a+b+c=1.00); and positive electrode active material β5 (LiMn_{0.450}Co_{0.450}Ti_{0.10}O₂) was prepared in such a manner that the ratio should become x:a:b:c=1:0.450:0.450:0.10 (a+b+c=1.00).

Similarly, on producing the positive electrode active material γ described above, positive electrode active material γ1 (LiMn_{0.495}Co_{0.495}Al_{0.01}O₂) was prepared in such a manner that the ratio x:a:b:c in LiₓMnₐCo_{b}Al_{c}O₂ should become x:a:b:c=1:0.495:0.495:0.01 (a+b+c=1.00); similarly, positive electrode active material γ2 (LiMn_{0.490}Co_{0.490}Al_{0.02}O₂: the same as γ above) was prepared in such a manner that the ratio should become x:a:b:c=1:0.490:0.490:0.02 (a+b+c=1.00); positive electrode active material γ3 (LiMn_{0.485}Co_{0.485}Al_{0.03}O₂) was prepared in such a manner that the ratio should become x:a:b:c=1:0.485:0.485:0.03 (a+b+c=1.00); positive electrode active material γ4 (LiMn_{0.475}Co_{0.475}Al_{0.05}O₂) was prepared in such a manner that the ratio should become x:a:b:c=1:0.475:0.475:0.05 (a+b+c=1.00); and positive electrode active material γ5 (LiMn_{0.450}Co_{0.450}Al_{0.10}O₂) was prepared in such a manner that the ratio should become x:a:b:c=1:0.450:0.450:0.10 (a+b+c=1.00).

Further similarly, on producing the positive electrode active material δ described above, positive electrode active material δ1 (LiMn_{0.495}Co_{0.495}Mg_{0.01}O₂) was prepared in such a manner that the ratio x:a:b:c in LiₓMnₐCo_{b}Mg_{c}O₂ should become x:a:b:c=1:0.495:0.495:0.01 (a+b+c=1.00); similarly, positive electrode active material 62 (LiMn_{0.490}Co_{0.490}Mg_{0.02}O₂: the same as δ above) was prepared in such a manner that the ratio should become x:a:b:c=1:0.490:0.490:0.02 (a+b+c 1.00); positive electrode active material δ3 (LiMn_{0.485}Co_{0.485}Mg_{0.03}O₂) was prepared in such a manner that the ratio should become x:a:b:c=1:0.485:0.485:0.03 (a+b+c=1.00); positive electrode active material δ4 (LiMn_{0.475}Co_{0.475}Mg_{0.05}O₂) was prepared in such a manner that the ratio should become x:a:b:c=1:0.475:0.475:0.05 (a+b+c=1.00); and positive electrode active material δ5 (LiMn_{0.450}Co_{0.450}Mg_{0.10}O₂) was prepared in such a manner that the ratio should become x:a:b:c=1:0.450:0.450:0.10 (a+b+c=1.00).

On obtaining X-ray diffraction patterns on each of the positive electrode active materials β1 to β4, γ1 to γ4, and δ1 to δ4, no peaks assigned to LiCoO₂ or LiMn₂O₃ were observed. Hence, they were found to have an α-NaFeO₂ crystal structure (a single phase layered crystal structure). On obtaining the X-ray diffractions patterns for the positive electrode active materials β5, γ5, and δ5, peaks assigned to LiCoO₂ or Li₂MnO₃ and the like; hence they were found to be a mixture of three phases differing in crystal structure.

Then, each of the positive electrodes h1 to h5, i1 to i5, and j1 to j5 were produced in a manner similar to above by using each of the positive electrode active materials β1 to β5, γ1 to γ5, and δ1 to δ5, and non-aqueous electrolyte secondary batteries H1 to H5, I1 to I5, and J1 to J5 were produced in a manner similar to above by using the negative electrodes described above. Each of the batteries H1 to H5, I1 to I5, and J1 to J5 was charged to a voltage of 4.2 V at a charge current of 500 mA (1 It) under an atmosphere kept at room temperature (about 25° C.), and on reaching 4.2 V, charging was performed at a constant voltage of 4.2 V until the charge current fell to 25 mA or lower. After stopping for 10 minutes, discharging was performed at a charge current of 500 mA (1 It) until the discharge final voltage became 2.75 V. Then, the initial charge and discharge efficiency was calculated according to equation (1) above to obtain results as shown in Table 7.

Furthermore, each of the batteries H1 to H5, I1 to I5, and J1 to J5, was charged to a voltage of 4.2 V at a charge current of 500 mA (1 It) under an atmosphere kept at room temperature (about 25° C.), and on reaching 4.2 V, charging was performed at a constant voltage of 4.2 V until the charge current fell to 25 mA or lower. After stopping for 10 minutes, discharging was performed at a charge current of 500 mA (1 It) until the discharge final voltage became 2.75 V. Thus, a cycle test comprising a step of 4.2 V-500 mA constant current-constant voltage charging and a step of 500 mA constant current discharging as 1 cycle was repeated to obtain the capacity retention ratio after 500 cycles ((discharge capacity after 500 cycles)/(discharge capacity after 1 cycle)×100%) to obtain results as shown in Table 7.

TABLE 7

| | Details of crystal structure of | | | | | Capacity | |
|---|---|---|---|---|---|---|---|
| | positive electrode active material | | | | | retention ratio | Initial charge |
| Type of | | | | | Crystal | after 500 | and discharge |
| battery | a | b | M | c | morphology | cycles (%) | efficiency (%) |
| H1 | 0.495 | 0.495 | Ti | 0.01 | Single phase | 80.4 | 96.5 |
| H2 | 0.490 | 0.490 | Ti | 0.02 | Single phase | 80.6 | 96.7 |
| H3 | 0.485 | 0.485 | Ti | 0.03 | Single phase | 80.3 | 96.8 |
| H4 | 0.475 | 0.475 | Ti | 0.05 | Single phase | 80.4 | 96.6 |
| H5 | 0.450 | 0.450 | Ti | 0.10 | Three phases | 68.9 | 92.1 |
| I1 | 0.495 | 0.495 | Al | 0.01 | Single phase | 76.4 | 96.3 |
| I2 | 0.490 | 0.490 | Al | 0.02 | Single phase | 76.5 | 96.6 |
| I3 | 0.485 | 0.485 | Al | 0.03 | Single phase | 76.5 | 96.5 |
| I4 | 0.475 | 0.475 | Al | 0.05 | Single phase | 76.3 | 96.3 |
| I5 | 0.450 | 0.450 | Al | 0.10 | Three phases | 63.4 | 91.9 |
| J1 | 0.495 | 0.495 | Mg | 0.01 | Single phase | 79.1 | 96.2 |
| J2 | 0.490 | 0.490 | Mg | 0.02 | Single phase | 79.3 | 96.1 |
| J3 | 0.485 | 0.485 | Mg | 0.03 | Single phase | 79.3 | 96.5 |
| J4 | 0.475 | 0.475 | Mg | 0.05 | Single phase | 79.0 | 96.4 |
| J5 | 0.450 | 0.450 | Mg | 0.10 | Three phase | 67.9 | 92.3 |

From the results shown in Table 7 above, it can be clearly understood that the batteries H5, I5, and J5 each using the positive electrode active materials β5, γ5, and δ5, i.e., each containing foreign elements such as Ti, Al and Mg at a substitution ratio of 0.10 mol %, yield lower values for the capacity retention ratio and the initial charge and discharge efficiency. Since the products tend to develop two or more phases with increasing amount of substitution for the foreign elements such as Ti, Al and Mg exceeding 0.10 mol %, these results are presumed attributed to the difficulty in maintaining the crystal morphology caused by a too high an amount of substitution. Accordingly, the amount of substitution of the foreign elements such as Ti, Al and Mg should be set to 0.05 mol % or lower (c=0.05). Furthermore, similar tendencies were observed for Li—Mn—Co based complex oxides using Sn and Zr as the substituting foreign element.

10. Relation Between the Value of (a+b+c) and Crystal Morphology

Subsequently, study was made on the relation between the value of (a+b+c) of a substituted type Li—Mn—Co based complex oxide expressed by the general formula LiₓMnₐCo_{b}Ti_{c}O₂ and the crystal morphology.

Firstly, lithium hydroxide, manganese oxide, cobalt oxide, and titanium oxide were mixed in such a manner to obtain compositions shown in Table 8 below (x=1.0, a/b=1, a≧0.45, b≦0.55, and 0.0<c≦0.05), and the resulting product was calcined in the same manner as that described above to obtain positive electrode active materials β6 to β11.

Then, lithium hydroxide, manganese oxide, cobalt oxide, and titanium oxide were mixed in such a manner to obtain compositions shown in Table 8 below (x=1.0, a≧0.45, b≦0.55, a>b, and 0.0<c≦0.05), and the resulting product was calcined in the same manner as that described above to obtain positive electrode active materials β12 to β17. Furthermore, lithium hydroxide, manganese oxide, cobalt oxide, and titanium oxide were mixed in such a manner to obtain compositions shown in Table 8 below (x=1.0, a≧0.45, b≦0.55, a>b, and 0.0<c≦0.05), and the resulting product was calcined in the same manner as that described above to obtain positive electrode active materials β18 to β22.

TABLE 8

| | Details of crystal structure | | | | |
|---|---|---|---|---|---|
| Type of | of positive electrode active material | | | | |
| positive | | | | | Crystal |
| electrode | a | b | c | a + b + c | morphology |
| β6 | 0.45 | 0.45 | 0.01 | 0.91 | Single phase |
| β7 | 0.47 | 0.47 | 0.01 | 0.95 | Single phase |
| β8 | 0.49 | 0.49 | 0.02 | 1.00 | Single phase |
| β9 | 0.51 | 0.51 | 0.03 | 1.05 | Single phase |
| β10 | 0.53 | 0.53 | 0.04 | 1.10 | Single phase |
| β11 | 0.55 | 0.55 | 0.05 | 1.15 | Three phases |
| β12 | 0.46 | 0.45 | 0.01 | 0.92 | Single phase |
| β13 | 0.47 | 0.46 | 0.02 | 0.95 | Single phase |
| β14 | 0.49 | 0.48 | 0.03 | 1.00 | Single phase |
| β15 | 0.51 | 0.50 | 0.04 | 1.05 | Single phase |
| β16 | 0.53 | 0.52 | 0.05 | 1.10 | Single phase |
| β17 | 0.55 | 0.54 | 0.05 | 1.14 | Three phases |
| β18 | 0.45 | 0.46 | 0.01 | 0.92 | Single phase |
| β19 | 0.46 | 0.47 | 0.02 | 0.95 | Single phase |
| β20 | 0.48 | 0.49 | 0.03 | 1.00 | Single phase |
| β21 | 0.50 | 0.51 | 0.04 | 1.05 | Single phase |
| β21 | 0.52 | 0.53 | 0.05 | 1.10 | Single phase |
| β22 | 0.54 | 0.55 | 0.05 | 1.14 | Three phases |

From Table 8 above, it can be clearly understood that the positive electrode active materials expressed by the general formula LiₓMnₐCo_{b}Ti_{c}O₂ can maintain the layered crystal structure in case the value of (a+b+c) falls in a range of from 0.90 to 1.10. On the other hand, in case the value of (a+b+c) falls outside the range of from 0.90 to 1.10, peaks assigned to LiCoO₂ or Li₂MnO₃ appear in the X-ray diffraction pattern to show the development of a mixture comprising two or more phases in crystal structure. Accordingly, the positive electrode active materials expressed by the general formula LiₓMnₐCo_{b}Ti_{c}O₂ should yield a value of (a+b+c) as such that it may satisfy the relation of 0.90<a+b+c≦1.10. Furthermore, similar tendencies were observed in case a substituted Li—Mn—Co based complex oxide containing Al, Mg, Sn, and Zr as the foreign elements was used.

As described above, in the present invention, there is used a positive electrode comprising a positive electrode active material containing admixed therein a lithium-containing complex oxide having a layered crystal structure expressed by the general formula LiₓMnₐCo_{b}O₂ (where, 0.9≦X≦1.1, 0.45≦a≦0.55, 0.45≦b≦0.55, and 0.9<a+b≦1.1) having admixed therein either lithium cobalt oxide or spinel-type lithium manganate; or a comprising a positive electrode active material containing admixed therein a lithium-containing complex oxide having a layered crystal structure expressed by the general formula LiₓMnₐCo_{b}Ti_{c}O₂ (where, 0.9≦X≦1.1, 0.45≦a≦0.55, 0.45≦b≦0.55, 0<c≦0.05, and 0.9<a+b+c≦1.1, and M represents at least one selected from the group consisting of Al, Mg, Sn, Ti, and Zr) having admixed therein either lithium cobalt oxide or spinel-type lithium manganate.

Hence, there can be obtained a non-aqueous electrolyte secondary battery exhibiting a plateau in the voltage region of 4V, which is almost equivalent to that using lithium cobalt oxide, having a high discharge capacity, and having superior battery characteristics such as cycle characteristics and high temperature characteristics.

In the embodiment described above, explanation was made on the case using lithium hydroxide as the lithium source; however, other lithium compounds such as lithium carbonate, lithium nitrate, or lithium sulfate may be used in the place of lithium hydroxide. Further, although explanation was made on the case using manganese oxide as the manganese source, there may be used manganese compounds such as manganese hydroxide, manganese sulfate, manganese carbonate, or manganese oxyhydroxide may be used in addition to manganese oxide. Furthermore, although explanation was made on the case using cobalt oxide as the cobalt source, there may be used cobalt compounds such as lithium carbonate, cobalt carbonate, cobalt hydroxide, or cobalt sulfate.

In the embodiment described above, explanation was made specifically on the case comprising mixing lithium hydroxide, manganese oxide, and cobalt oxide in the state of hydroxides, and after adding therein a foreign element, calcining the resulting product. However, a lithium source, a manganese source, a cobalt source, and a foreign element may be calcined in the solid state.

Furthermore, on adding foreign element such as Ti, Al, Mg, Sn, or Zr in the embodiment described above, explanation was made specifically on the case of adding oxides of foreign element such as Ti, Al, Mg, Sn, or Zr. However, there is no need of using the oxides of foreign element such as Ti, Al, Mg, Sn, or Zr, and there may be added sulfides or hydroxides of the foreign element such as Ti, Al, Mg, Sn, or Zr.

Moreover, in the embodiment described above, explanation was made on the case of applying the invention to a non-aqueous electrolyte secondary battery using an organic electrolyte. However, it is apparent that the invention is applicable to a non-aqueous electrolyte secondary battery using a polymer solid electrolyte. In such a case using a polymer solid electrolyte, preferred as the solid electrolyte are, a polycarbonate based solid polymer, a polyacrylonitrile based solid polymer, and a copolymer or crosslinked polymer comprising two types or more thereof; or a gel-like solid electrolyte obtained by combining a fluorine-containing solid polymer such as poly(vinilidene fluoride) (PVdF) with a lithium salt and an electrolytic solution.

What is claimed is:

1. A non-aqueous electrolyte secondary battery comprising a positive electrode containing a positive electrode active material capable of intercalating and deintercalating lithium ions, a negative electrode containing a negative electrode active material capable of intercalating and deintercalating lithium ions, a separator between the positive electrode positive electrode and the negative electrode negative electrode, and a non-aqueous electrolyte, wherein
said positive electrode comprises added therein a lithium-containing composite oxide having a layere crystal structure represented by general formula LiXMnaCobO2(where X is a value of 0.9 or greater but not greater than 1.1, a is a value of 0.45 or greater but not greater than 0.55, b is a value of 0.45 or greater but not greater than 0.55, and the sum of a and b is greater than 0.9 but not greater than 1.1), together with either of a lithium cobalt oxide and a spinel-type lithium manganese oxide.

2. A non-aqueous electrolyte secondary battery as claimed in claim 1, wherein said lithium-containing composite oxide and said lithium cobalt oxide are admixed in such a manner that the ratio B/(A+B) should be 0.4 or greater but less than 1.0, where A represents the mass of the lithium-containing composite oxide and B represents the mass of lithium cobalt oxide.

3. A non-aqueous electrolyte secondary battery as claimed in claim 1, wherein said lithium-containing composite oxide and said spinel-type lithium manganese oxide are admixed in such a manner that the ratio C/(A+C) should be greater than 0 but less than 0.4, where A represents the mass of the lithium-containing composite oxide and C represents the mass of spinel-type lithium manganese oxide.

4. A non-aqueous electrolyte secondary battery as claimed in one of claims 1 to 3, wherein the lithium-containing composite oxide expressed by general formula LiXMnaCobO2 is synthesized in such a manner that the ratio a/b should be a value greater than 0.9 but smaller than 1.1.

5. A non-aqueous electrolyte secondary battery as claimed in one of claims 1 to 4, wherein the lithium-containing composite oxide is substituted by a foreign element M, and is represented by general formula LiXMnaCobMcO2 (where X is a value of 0.9 or greater but not greater than 1.1, a is a value of 0.45 or greater but not greater than 0.55, b is a value of 0.45 or greater but not greater than 0.55, c is a value greater than 0 but not greater than 0.05, and the sum of a, b and c is greater than 0.9 but not greater than 1.1).

6. A non-aqueous electrolyte secondary battery as claimed in claim 5, wherein the foreign element M is at least one selected from the group consisting of Al, Mg, Sn, Ti, and Zr.
